(19) United States
(12) Patent Application Publication
(10) Pub. No.: US 2025/0369350 A1
(43) Pub. Date: Dec. 4, 2025

(54) Method and Apparatus For Deep Electromagnetic Communication

(71) Applicant: Gunnar LLLP, Magnolia, TX (US)

(72) Inventor: Clinton Moss, Bakersfield, CA (US)

(73) Assignee: Gunnar LLLP, Magnolia, TX (US)

(21) Appl. No.: 18/732,739

(22) Filed: Jun. 4, 2024

(51) Int. Cl. E21B 47/13; H01Q 1/04

(52) U.S. Cl. CPC E21B 47/13; H01Q 1/04

(57) ABSTRACT

Methods and systems are disclosed for the augmentation of Electromagnetic (EM) telemetry by way of lengthening the lower antenna of the system by way of wired drill pipe. Wired drill pipe segments which allow for a continuous electrical power transmission and physical connection of multiple sections of drill pipe so that the anode of the EM transmitter can be effectively displaced farther up hole in the drill string, thereby lengthening the lower antenna portion of the telemetry system, resulting in enhanced signal amplitude both received and transmitted by the bi-directional subterranean communication or formation logging system.

### BACKGROUND

### Field of the Invention

The present disclosure relates to devices and methods for deep electromagnetic communications systems and their uses in communication as well as evaluation of borehole properties.

### BACKGROUND OF THE INVENTION

Electromagnetic telemetry for borehole drilling is a technology that involves the use of electromagnetic waves to transmit and receive data in the context of drilling and exploring boreholes in the Earth's subsurface. It plays a crucial role in various industries, including oil and gas, mining, geothermal energy, and groundwater exploration. This technique allows operators to gather critical information about the wellbore, such as its position, orientation, and physical properties.

The basic principle of electromagnetic telemetry involves the use of a downhole tool, commonly referred to as a measurement while drilling (MWD) tool, which is deployed into the borehole during the drilling process. The MWD tool can comprise various sensors, including accelerometers, magnetometers, and resistivity sensors, which gather relevant data about the surrounding formations and transmit it to the surface in real time.

The communication between the downhole MWD tool and the surface typically relies on electromagnetic waves. In most cases, low-frequency alternating currents are induced in the drill string or casing, which act as antennas for transmitting and receiving signals. These signals are modulated with the downhole data, allowing the surface equipment to extract meaningful information about the wellbore conditions.

One of the significant advantages of electromagnetic telemetry is its ability to provide real-time data, enabling operators to make informed decisions during the drilling process. By monitoring variables such as drilling parameters, formation characteristics, and wellbore trajectory, they can optimize drilling operations, enhance safety, and reduce costs.

Electromagnetic telemetry also offers the advantage of being relatively immune to certain drilling challenges. For instance, it is less affected by drilling fluid properties, such as mud density or viscosity, compared to other telemetry methods like mud pulse telemetry. This makes it suitable for drilling in challenging environments where conventional techniques may encounter limitations.

Furthermore, electromagnetic telemetry can be utilized for additional purposes beyond real-time data transmission. For example, it can be employed for electromagnetic imaging techniques to obtain detailed information about the surrounding formations, identify geological features, and detect potential hazards such as fractures or fluid influxes. This capability enhances the overall understanding of the subsurface conditions and contributes to improved wellbore planning and management.

Related closely to electromagnetic communications is the concept of resistivity logging. Resistivity logging, also known as electrical resistivity logging, is a wellbore measurement technique used in the field of geophysics to evaluate the electrical properties of subsurface formations. By measuring the resistance to electrical current flow in the surrounding rocks, resistivity logging provides valuable information about the composition, porosity, and fluid content of the formations.

The basic principle of resistivity logging involves sending a controlled electric current into the formation through the wellbore and measuring the resulting voltage. The measured voltage is then used to calculate the formation's resistivity, which is a measure of its ability to conduct electricity.

The resistivity of a formation is influenced by various factors, including the presence of fluids (such as water, oil, or gas), the mineral composition of the rocks, and the porosity of the formation. Generally, formations with high resistivity indicate low fluid content and high rock density, while formations with low resistivity suggest the presence of fluids and lower rock density.

Different types of resistivity logging tools are used to measure resistivity at various depths within the wellbore. Some common types include:
1. Induction Logging: Uses electromagnetic fields to induce currents in the formation, measuring the voltage response to determine resistivity.
2. Focused Resistivity Tools: Utilize multiple electrodes or pads to provide focused measurements and obtain more detailed information about the formation.
3. Microresistivity Tools: Employ small electrodes or buttons to measure resistivity in thin-bedded formations or near the wellbore wall.

Resistivity logging data is typically presented in the form of resistivity logs or curves, which show variations in resistivity with depth. These logs help geoscientists and engineers identify different lithologies, evaluate fluid content, map reservoir properties, and make informed decisions regarding drilling, production, and reservoir management.

By combining resistivity data with other well log measurements, such as gamma ray, neutron, and density logs, a comprehensive understanding of subsurface formations can be achieved. This information aids in reservoir characterization, identifying productive zones, and optimizing hydrocarbon recovery.

As stated, resistivity logging relies on sending an electric current into the surrounding location, and measuring the resulting voltage induced in the surrounding strata. To accomplish this, spacing between the transmitting and receiving antennas is critical, as the greater the spacing between the transmitter and receiver, the greater the depth of investigation of the electromagnetic logging device. A need to conveniently space the sensor and receiver for the purposes of electromagnetic derived formation logging is one requirement of industry that this patent seeks to address. This patent also seeks to address effective methods and systems for electromagnetic telemetry and communications systems.

### BRIEF DESCRIPTION OF THE DRAWINGS

FIG. 1 is an example of a dipole antenna.

FIG. 2 is an example of a typical downhole antenna for an electromagnetic communications system.

FIG. 3 is an example of a way to elongate the antenna section of an electromagnetic communications system.

FIG. 4A is a simplified example of an elongated antenna section of an electromagnetic communications system.

FIG. 4B is a simplified example of an electromagnetic communications system in use today.

FIG. 5 is a example of an elongated antenna with wired pipe.

### DETAILED DESCRIPTION OF THE INVENTION

The electromagnetic (EM) system consists of various components that work together to enable data transmission and reception in borehole drilling operations. These components, including the gap sub, are strategically placed within the Bottom Hole Assembly (BHA) to optimize their functionality. The following are the key parts of the EM system:

Gap Sub: The gap sub is a component placed in the BHA to provide an air gap or non-conductive medium between the conductive drill string and the downhole telemetry system. It is typically positioned above or below the MWD tools and antennas within the BHA. The gap sub acts as an interface, facilitating efficient signal transmission and reception by minimizing signal attenuation and interference caused by the conductive drill string.

MWD Tools: Measurement While Drilling (MWD) tools are an integral part of the EM system. These tools, such as accelerometers, magnetometers, resistivity sensors, and gamma ray detectors, are placed in the BHA to collect downhole data during drilling operations. The MWD tools process the data and transmit it to the surface via the EM system for real-time monitoring and decision-making.

Antennas: Antennas are critical components of the EM system, responsible for transmitting and receiving electromagnetic signals between the downhole and surface equipment. While Whip antennas, loop antennas, or coil antennas can be used in the EM system, standard EM systems typically employ what most closely resembles a dipole antenna. This antenna configuration is brought about by the installation of the Gap sub in the BHA so as to electrically isolate positive and return terminals from the electromagnetic transceiver.

Transmitters and Receivers: Transmitters and receivers are the electronic components responsible for generating and detecting electromagnetic signals within the EM system. These devices are typically located in the downhole telemetry system or surface equipment. The transmitters generate signals that are transmitted through the antennas, while the receivers detect and process the received signals, allowing for data retrieval and analysis.

Telemetry System: The telemetry system encompasses the electronics, processors, and software that enable the transmission and reception of data in the EM system. It includes the data encoding and decoding mechanisms, signal processing algorithms, and communication protocols necessary for reliable data communication between the downhole and surface equipment.

The dipole antenna is a fundamental type of radio antenna commonly used for transmitting or receiving radio waves. It is one of the simplest and most widely used antenna designs due to its balanced radiation pattern and relatively straightforward construction.

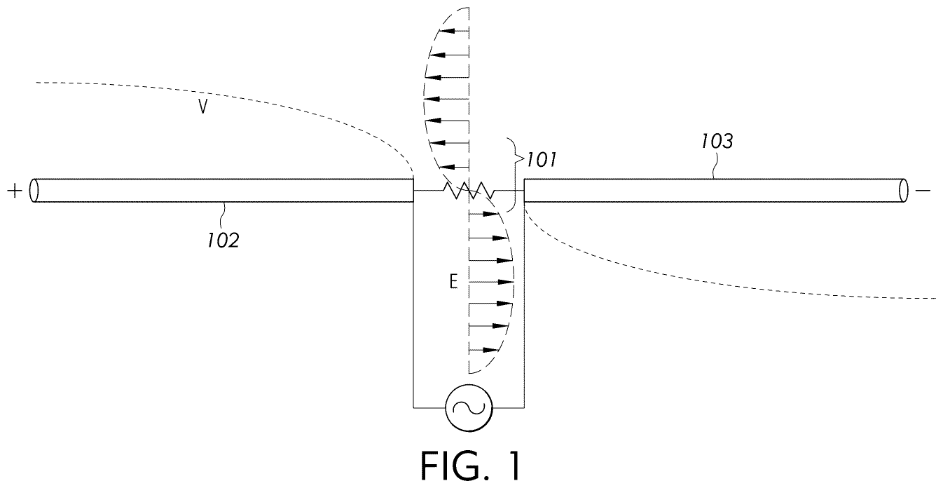

The dipole antenna consists of a conductive wire or rod that is split into two equal halves and fed at the center. The center point where the antenna is fed is known as the feed point or the center feed. The two halves are typically oriented in a straight line, with each half extending in opposite directions (FIG. 1). As shown in FIG. 1, the feed point 101 is at the mid point of the dipole antenna. Each half 102 and 103 of the dipole antenna are roughly of the same length. The radiation pattern of the dipole antenna is perpendicular to the conductor of the antenna. The dipole antenna radiates energy out into the space perpendicular to its axis.

The length of the dipole antenna is typically half the wavelength of the radio frequency it is designed to operate at. This length is known as the resonant length and is calculated based on the desired frequency of operation. For example, if the antenna is intended for operation at a frequency of 100 MHz, the resonant length of the dipole would be approximately 1.5 meters (λ/2).

When the dipole antenna is energized with an alternating current, it generates electromagnetic waves that radiate into space. The radiation pattern of the dipole antenna is symmetrical, with the maximum radiation occurring perpendicular to the wire, in the plane of the antenna. The pattern resembles a torus or donut shape, with minimal radiation occurring off the ends of the antenna.

The dipole antenna is considered omnidirectional, meaning it radiates and receives signals equally well in all directions perpendicular to the wire. This characteristic makes the dipole antenna suitable for applications where a wide coverage area is desired, such as in broadcast radio or Wi-Fi networks.

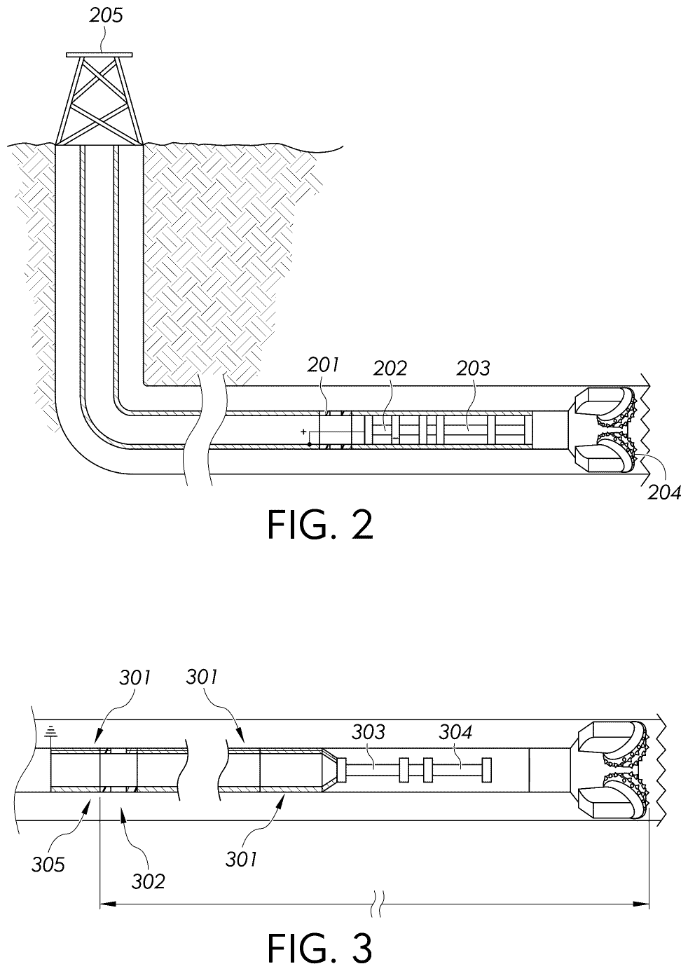

In a subterranean telemetry system for wellbore drilling, each half of the dipole antenna is physically made up of sections of drill pipe, with the center point of the antenna being represented by the gap sub 201 (FIG. 2). Since the purpose of the telemetry system is to provide information from drilling sensors near the drill head, the entire MWD and telemetry system is typically installed within 30-50 meters from the bit 204, with the EM gap sub 201 typically being installed as the last component in the BHA (closest to surface, the farthest component from the bit 204), above the electromagnetic transceiver 202, MWD sensors 203, etc. Effectively, this makes the lower portion of the antenna (from the gap sub 201 to the drill bit 204) 50 meters long, with the upper length corresponding to the remaining drillstem length from the gap sub 201 up to the drilling rig 205, which could be thousands of meters long (this is simply the balance of lower antenna length and current borehole total depth). This is less than ideal, as the length of the antenna on either side of the feedpoint is not in balance. Further, since EM systems use low frequency AC wave propagation (˜1-100 hz), the short downhole side of the dipole antenna impedes signal detection. Ideally, the antenna length on either side of the feed point would be approximately equal to 2, with a 100 hz signal having a wavelength of 3,000,000 meters. While it is not possible to achieve this length of antenna downhole, it stands to reason that increasing the effective length on either side of the dipole antenna feed point is desired, as doing so causes the dipole dimensions to approach the ideal theoretical length. In the most preferred embodiment, each half of the dipole antenna are the same length. In other preferred embodiments, the difference in length of each dipole antenna 102 and 103 are within 20%, more preferably 10%, and yet more preferably 5%.

To increase the overall length of the downhole portion of the antenna, the gap sub must be moved axially closer to the origin of the drill stem, as opposed to its terminus (the drill bit). One method disclosed in the prior art involves the placement of at least one insulated wire inside the drillstring. The wire is connected to the top of the EM transmitter that remains positioned close to the drill head. This wire is then threaded through each successive piece of drill pipe as they are installed at surface at the drill floor of the drilling rig, with each wire been connected to the previous and then insulated. Once the desired length of drill pipe has been installed above the EM transmitter, the Gap sub is installed and the wire is terminated on the top side of the isolation gap sub. Effectively, this shifts the feed point of the dipole system hundreds of feet farther uphole then it otherwise would be. Alternatively, once the desired number of drill pipes has been installed, the wire can be lowered into the drill pipe and latched onto and so as to make electrical connection with the excitation terminal of the EM transmitter. While this technique does indeed lengthen the lower portion of the antenna dipole, it introduces complications and limitations to drilling operations in that it: introduces an un-centralized long wire which will twist and strike the inside diameter of the drill string as it is rotated. Further, this wire presents and obstruction in the drill string which prevents oilfield “fishing” operations, and is otherwise subject to mechanical damage and malfunction due to vibrations and mud flow wear during drilling operations.

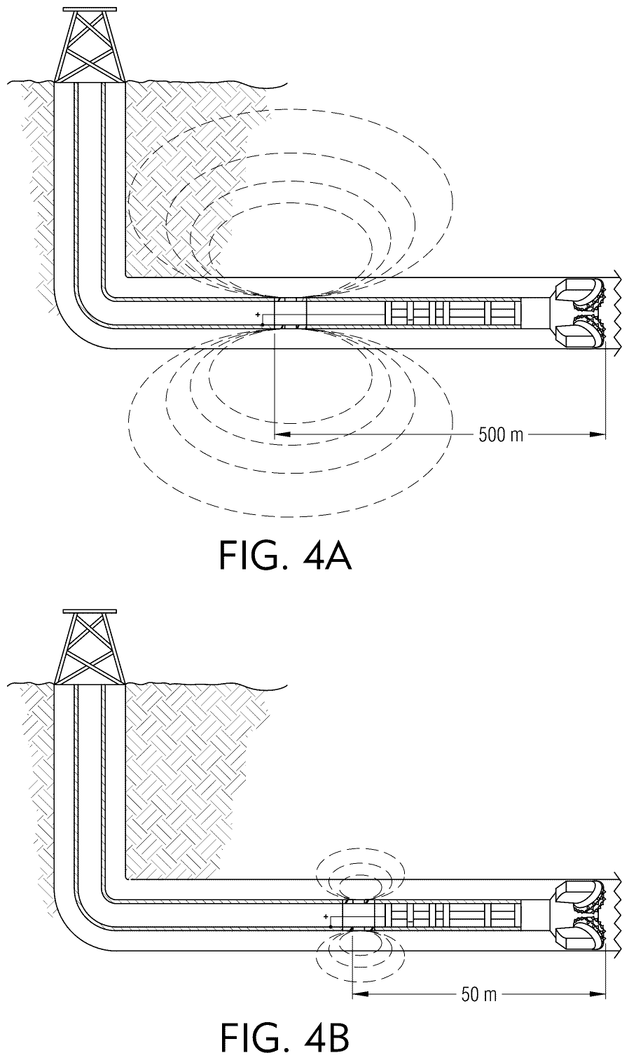

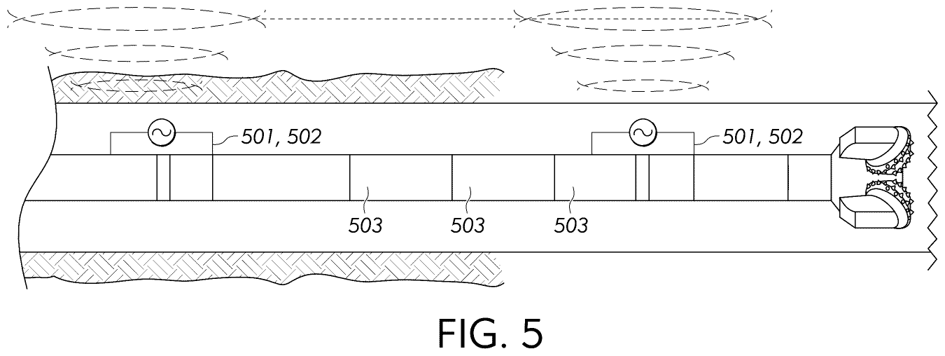

An improved method and apparatus for elongating and otherwise configuring and optimizing antenna dimensions for a subterranean electromagnetic transmitter is disclosed. To increase the downhole portion of the dipole antenna, the feed point of the antenna system, which is defined by the gap sub placement in the drill string is disclosed. This system is disclosed in FIG. 3. To move the effective feed point of the antenna system up hole 305, wired drill pipes 301 can be employed. In one embodiment of the invention, the MWD system 304 is installed as close to the bit as is practical and desirable, however, in this configuration, the gap sub 302 is not placed directly on top of the EM transceiver 303. Instead, the excitation terminal of the transceiver is connected directly to at least one section of wired drill pipe. This wired drill pipe can be the of the variety described in application US 2019/0119990 A1 (which is incorporated herein in total by reference), which provides a rigid physical connection between insulated segments, thereby allowing power transmission, as opposed to the version of wired drill pipe which requires toroidal inductive coupling between drill pipe sections, as is described in U.S. Pat. No. 6,641,434. As each successive wired pipe is attached, the electrical connection between the transceiver is elongated. Once the desired length of the downhole section of the antenna dipole has been achieved through the installation of one or more wired pipe segments, the gap sub 302 can be installed. The gap sub can be modified so that the insulated conductor(s) of the wired pipe can be fed through and be terminated above the electrically insulated gap of the sub. The ability to feed through the electrical connection to the transceiver, which has been elongated by the insulated conductor(s) of the wired pipe segments, can be achieved by axially gun drilling a channel through the body of gap sub, and then feeding at least one insulated conductor to the topside of the gap sub, and then terminating said conductor above the isolation point of the sub (FIG. 3). Effectively, this configuration allows the feed point of the dipole antenna to be positioned as far back from the drill pipe as is desired by installing more or less wired pipe segments on the top side of the downhole EM transceiver. Alternatively, the gap sub itself can have an insulated wire coating on the ID of the sub using the methods described in US 2019/0119990 A1 (which is incorporated herein by reference), thereby allowing the transceiver terminal to be passed uphole across the insulative gap sub, and then electrically and physically terminated to the steel body of the drill string above the gab sub. These are but two ways in which an electrical channel can be passed across the EM gap sub without affecting the inside mechanical profile of the drill pipe and subs contained in the bottom hole assembly. One of skill in the art will appreciate that there are also alternative ways to accomplish this result. By elongating the downhole portion of the dipole by way of wired pipe segments extended, the effective feed point of the antenna is moved closer uphole. This achieves the effect of optimizing the antenna length of the downhole section of the antenna dipole, thereby increasing distance of propagation of the transmission, FIG. 4a, vs. the limited propagation of current systems, FIG. 4b.

For the purposes of electromagnetic resistivity logging, the present invention(s) also allow for a convenient means to space the EM emitter from the receiver. Typically, receiver and transmitter antenna spacing for a resistivity logging tool are accomplished by having the two devices wired together by a common bus line which is extended through a sonde that is concentrically mounted inside the drill pipe. Alternatively, for extended spacing, a separate battery pack is mounted to a distal uphole or downhole transmitter in the drill pipe that is then synchronized via suitable telemetric means. While successful, these techniques introduce complexity into the operation as: 1) There is a practical limit to how far one can extend a concentric mounted bus line as this introduces cost, complexity and failure points to the BHA, 2) the introduction of remote battery driven transmitters complicate synchronization while limiting (due to the remote battery pack) the ampacity and voltage output of the system and 3) both techniques introduce ID restrictions inside the drill pipe and prevent conventional fishing operations past these ID obstructions. These constraints are effectively eliminated by the invention, as the wired pipe sections 503 can be used to conveniently space the transmitter(s) 501, 502 and receiver(s) 501, 502 of the resistivity logging device axially along the BHA without introducing a concentric obstruction, and without the need to introduce additional battery packs for remote transmitters or remote receivers.

While the invention has been illustrated and described in detail in the drawings and foregoing description, the same is to be considered as illustrative and not restrictive in character, it being understood that only the preferred embodiments have been shown and described and that all changes and modifications that come within the spirit of the invention are desired to be protected.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. An apparatus for conducting resistivity logging comprising:
a first length of continuous wired pipe in a formation;
a second length of continuous wired pipe in the formation, the second length of continuous wired pipe is within 20% of the length of the first length of continuous wired pipe;
a gap sub connecting the first length of continuous wired pipe and the second length of continuous wired pipe
an electromatic transmitter for conducting resistivity logging of the formation placed in the continuous wired pipe at a distance from the gap sub;
a receiver for conducting resistivity logging of the formation and placed in the continuous wired pipe at a distance from the gap sub that is within 20% of the distance of the electromagnetic transmitter from the gap sub.

15. The apparatus of claim 14 wherein the receiver for conducting resistivity logging is placed in the continuous wired pipe at a distance from the gap sub that is within 10% of the distance of the electromagnetic transmitter from the gab sub.

16. The apparatus of claim 14 wherein the receiver for conducting resistivity logging is placed in the continuous wired pipe at a distance from the gap sub that is within 5% of the distance of the electromagnetic transmitter from the gab sub.

17. The apparatus of claim 14 wherein the receiver for conducting resistivity logging is placed in the continuous wired pipe at a distance from the gap sub that is equal to the distance of the electromagnetic transmitter from the gab sub.

18. A method for carrying out resistivity logging of a formation comprising the steps of:
installing a drill bit in a borehole;
installing an MWD unit in the borehole;
installing a gap sub in the borehole;
installing an electromatic transmitter for conducting resistivity logging of a formation in the borehole;
installing connected wired pipe of a first length in the borehole;
installing a second gap sub in the borehole;
installing a second length of wired pipe in the borehole, the second length of wired pipe within 20% of the length of the first wired pipe;
installing a receiver in the borehole;
causing the electromagnetic transmitter to emit a signal for measuring the resistivity of the formation;
causing the receiver to receive the signal emitted by the electromagnetic transmitter for measuring the resistivity of the formation;
calculating the resistivity of the formation;
continuing to drill;
causing the electromagnetic transmitter to emit a signal for measuring the resistivity of the formation;
causing the receiver to receive the signal emitted by the electromagnetic transmitter for measuring the resistivity of the formation;
calculating the resistivity of the formation.

19. The method of claim 18 wherein the connected wired pipe of the second length is installed to be within 10% of the length of the first length of connected wired pipe.

20. The method of claim 18 wherein the connected wired pipe of the second length is installed to be within 5% of the length of the first length of connected wired pipe.

21. The method of claim 18 wherein the connected wired pipe of the second length is installed to be the same length of the first length of connected wired pipe.
